(19) United States
(12) Patent Application Publication
(10) Pub. No.: US 2007/0057407 A1
(43) Pub. Date: Mar. 15, 2007

(54) Method and device for laying a section of railway

(76) Inventor: Jacob Johan Schildmeijer, Delft (NL)

Correspondence Address: YOUNG & THOMPSON, 745 SOUTH 23RD STREET, 2ND FLOOR, ARLINGTON, VA, 22202, US

(21) Appl. No.: 10/575,161

(22) PCT Filed: Oct. 8, 2004
(86) PCT No.: PCT/NL04/00711

§ 371 Date: Jul. 10, 2006

(30) Foreign Application Priority Data
Oct. 9, 2003 (NL) 1024494

(51) Int. Cl. B28B 3/00

(52) U.S. Cl. 264/333

(57) ABSTRACT

A method for laying a section of railway including a railway track consisting of two rails and sleepers with which the rails are linked to one another, and a foundation on which the railway track is supported, includes the following steps: preparing the foundation, supporting the railway track with banking some distance above the foundation, pouring concrete between the sleepers and the foundation as well as making the banking of the railway track and the foundation different.

The invention relates to a method for laying a section of railway comprising a railway track consisting of two rails and sleepers by means of which the rails are linked to one another, and a foundation on which the railway track is supported, comprising the following steps:
preparation of the foundation,
supporting the railway track with banking some distance above the foundation,
pouring concrete between the sleepers and the foundation.

Such a method is disclosed in EP-A 379 148. According to this known method the foundation can be made as a concrete slab to which the railway track is fixed by pouring concrete into the open spaces between said slab and the railway track. The section of railway is ready after the concrete has set. In the case of straight railway tracks an essentially horizontal concrete slab is used, which optionally can have a slight fall towards both longitudinal edges. In the case of curved section of railways a concrete slab that slopes down towards the inside of the curve is employed.

In both cases a gap between the sleepers of the railway track and the concrete slab arises as a result. This gap is virtually identical for the straight and the curved section of railway. In the light of this it is therefore necessary to provide the slope of the curved concrete slab with an accurately constructed incline, since otherwise the finished section of railway does not have the desired angle of inclination.

The aim of the invention is therefore to provide a method by means of which the angle of inclination of a section of railway can be set in a simple and flexible manner. Said aim is achieved by the step of making the banking of the railway track and the foundation different. In the method according to the invention the angle of inclination of the railway track with respect to the foundation is modified such that irrespective of the angle of inclination of, for example, a concrete foundation slab, the correct angle of inclination of the railway track can be chosen. As a result it is also possible to work with horizontal foundations over the entire section of railway, i.e. also in the curved sections thereof.

The gap between the railway track and the foundation is then filled with concrete in a manner known per se, except that viewed in the transverse direction, different amounts of concrete are poured per unit length of the railway track. In other words, in the region in which the distance between the railway track and the foundation is greatest (outside curve) more concrete is poured than elsewhere (inside curve).

Pouring the concrete in this way can be carried out in various ways, either discontinuously as described in EP-A 379 148, already mentioned above, or continuously, as described in EP-A 1 191 145. Preferably the method according to the invention comprises pouring the concrete by means of several discharge openings that are alongside one another in the transverse direction. In connection with the differences in height in the outside curve and the inside curve, the invention can also comprise the step of setting the discharge openings to heights that differ from one another, preferably at essentially the same distance from the sleepers.

The invention also relates to a device for carrying out the method as described above for laying a section of railway with a railway track consisting of two rails as well as sleepers by means of which the rails are linked to one another, and a foundation on which the railway track is supported, comprising a chassis that can be moved along and over the section of railway, which chassis has several discharge openings, the height of which can be adjusted relative to the chassis and which are alongside one another viewed in the transverse direction of the chassis, as well as means for feeding ready-mix concrete to said discharge openings.

Such a device is also disclosed in EP-A 379 148. With this device discharge openings are used that are at the same height with respect to one another. According to the invention provision is made that the discharge openings can be set at different heights with respect to one another. With this arrangement the discharge openings can be linked to one another, such that a fixed relationship between the different heights of the discharge openings is ensured, but this is not necessary. For instance, the discharge openings could also be individually adjustable in height.

The invention furthermore relates, in combination, to a device as described above as well as support tracks that can be installed along the section of railway to be laid to support the device. In this context the device can have roller members, whilst the support tracks can have a channel shape, in which channel shape the roller members can be accommodated. A hopper can also be provided for a quantity of ready-mix concrete, as well as means for transferring the ready-mix concrete from the hopper to the discharge openings.

The invention will be explained in more detail below with reference to an illustrative embodiment shown in the figures.

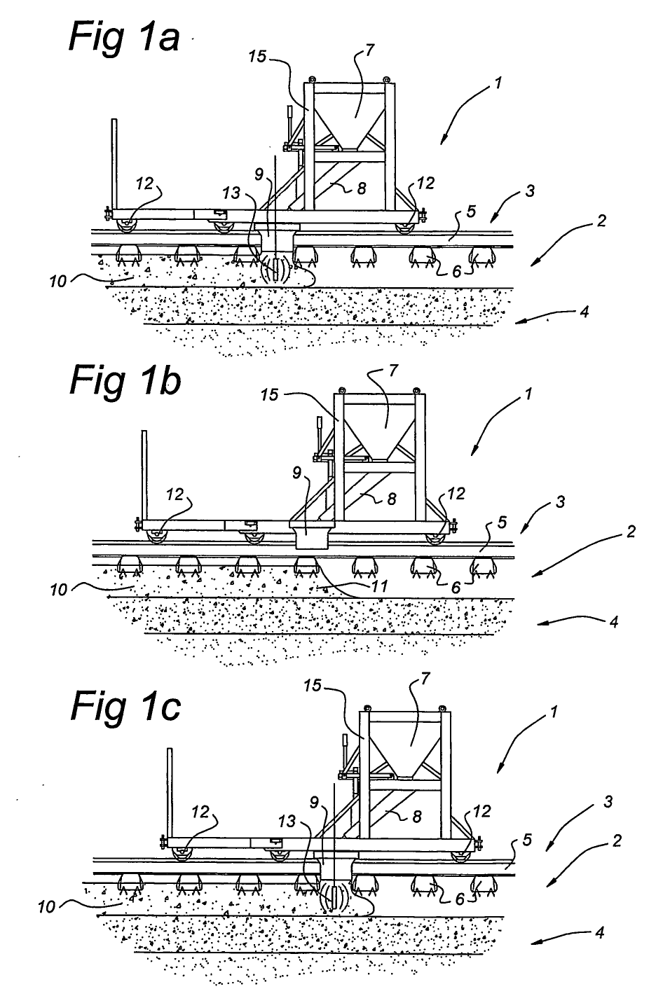

FIGS. 1a-c show the device according to the invention when carrying out the method.

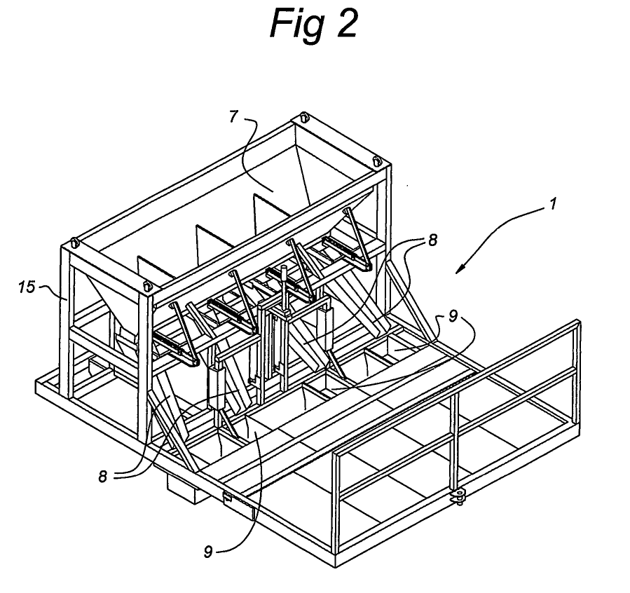

FIG. 2 shows a perspective view of part of the device.

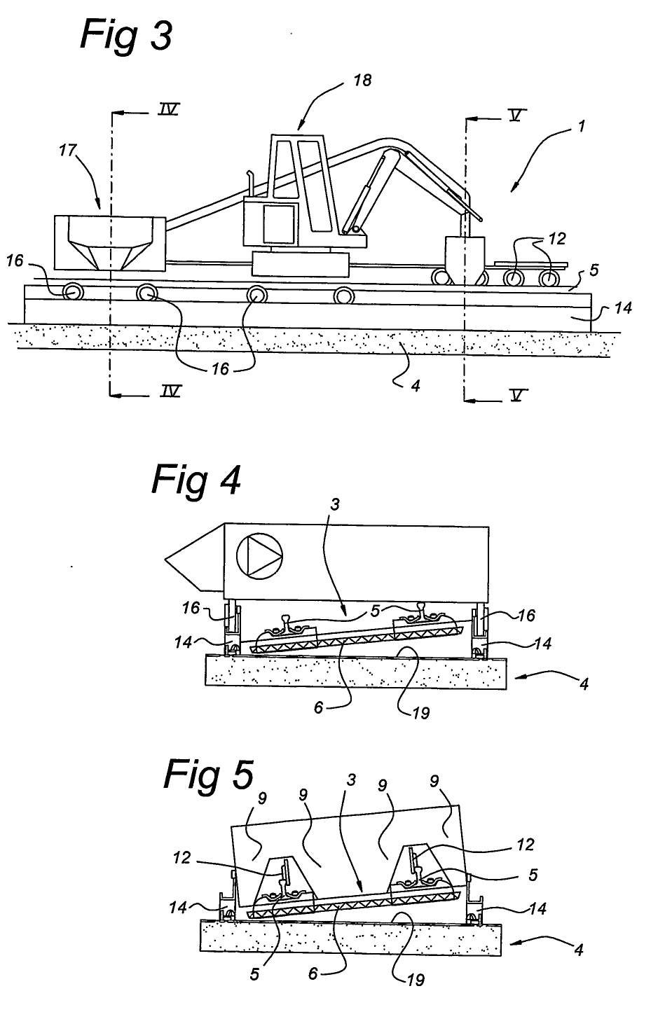

FIG. 3 shows a side view of a combination with the device according to the invention.

FIG. 4 shows a section along IV-IV in FIG. 3.

FIG. 5 shows a section of V-V in FIG. 3.

The device 1 according to the invention shown in FIGS. 1 a-c is used when laying a section of railway 2, comprising a railway track 3 and a foundation 4. The railway track 3 comprises two rails 5 that are linked to one another by a series of sleepers 6.

The device 1 comprises a chassis 15, on which there is a hopper 7 with chutes 8, four in total, as shown in the perspective view in FIG. 2.

Concrete mass contained in the hopper 7 is fed via the chutes 8 to the pouring tubes 9, four of which are also provided.

In the situation in FIG. 1a these pouring tubes 9 have been moved downwards into a fully lowered position in which they are between the sleepers 6. In this position the concrete mass 10 is poured between the sleepers 6 and the foundation 4, such that the railway track 3 is provided with a firm foundation.

As shown in FIG. 1b, the concrete mass can flow out to some extent below the sleepers 6 at 11. The pouring tubes 9 are then moved upwards into a fully raised position and the device 1 is moved, in this case by means of wheels 12 over the rails 5. When the device has reached the next pair of sleepers 6, the discharge openings 9 are lowered again, after which pouring can be continued.

During pouring the needle vibrators 13 are used in order to obtain the desired compaction in the poured concrete mass 10.

In the variant in FIGS. 3-5 it is shown that the device 1 can also be constructed in a different way. The device 1 once again has wheels 12 that are supported on the rails 5. The auxiliary vehicles 17, 18 have roller members 16 that are supported in separate troughs 14 that are on the foundation 4. The foundation, for example a concrete slab, has a flat top 19.

The railway track 3 is supported at an angle some distance above said flat top 19, as can be the case in a curve. The discharge openings 9 are now at different heights, such that they are able to follow the incline of the railway track 3 in the transverse direction.

### LIST OF REFERENCE SYMBOLS

1. Device
2. Section of railway
3. Railway track
4. Foundation
5. Rails
6. Sleepers
7. Hopper
8. Chutes
9. Pouring tubes/discharge openings
10. Concrete mass
11. Outflow
12. Wheels
13. Needle vibrators
14. Separate channels/support tracks
15. Chassis
16. Roller members
17. Auxiliary vehicles
18. Auxiliary vehicles
19. Flat top

1-11. (canceled)

12. Method for laying a section of railway (2) comprising a railway track (3) consisting of two rails (5) and sleepers (6) by means of which the rails (5) are linked to one another, and a foundation (4) on which the railway track (3) is supported, comprising the following steps:
preparation of the foundation (4),
supporting the railway track (3) with banking some distance above the foundation (4),
pouring concrete (10) between the sleepers (6) and the foundation (4),
making the banking of the railway track (3) and the foundation (4) different, and
pouring the concrete (10) by means of several discharge openings (9) that are alongside one another in the transverse direction characterized by:
setting the discharge openings (9) at heights that differ from one another.

13. Method according to claim 12, comprising, viewed in the transverse direction, pouring different amounts of concrete (10) per unit length of the width of the railway track (3).

14. Method according to claim 12, comprising setting the discharge openings (9) at essentially the same distance with respect to the sleepers (6).

15. Method according to claim 13, comprising setting the discharge openings (9) at essentially the same distance with respect to the sleepers (6).

16. Device (1) for carrying out the method according to claim 12 for laying a section of railway (2) with a railway track (3) consisting of two rails (5) as well as sleepers (6) by means of which the rails (5) are linked to one another, and a foundation (4) on which the railway track (3) is supported, comprising a chassis (15) that can be moved along and over the section of railway (2), which chassis (15) has several discharge openings (9), the height of which can be adjusted relative to the chassis (15) and which are alongside one another viewed in the transverse direction of the chassis (15), as well as means (8) for feeding ready-mix concrete (10) to said discharge openings (9), characterized in that the discharge openings (9) can be set heights that differ from one another.

17. Device according to claim 16, wherein the discharge openings (9) are linked to one another.

18. In combination, a device (1) according to claim 16, as well as support tracks (14) that can be installed on the foundation (4) for the section of railway (2) to be laid in order to support the device (1).

19. Combination according to claim 17, wherein auxiliary vehicles (17, 18) are provided that have wheels (16) and the support tracks (14) have a channel shape; in which channel shape the roller members (16) can be accommodated.

20. Combination according to claim 18, also comprising a hopper (7) for a quantity of ready-mix concrete (10), as well as means (8) for transferring the ready-mix concrete (10) from the hopper (7) to the discharge openings (9).

21. Combination according to claim 18, wherein the device (1) has wheels (12) that can be supported on the rails (5).

22. In combination, a device (1) according to claim 17, as well as support tracks (14) that can be installed on the foundation (4) for the section of railway (2) to be laid in order to support the device (1).

23. Combination according to claim 19, also comprising a hopper (7) for a quantity of ready-mix concrete (10), as well as means (8) for transferring the ready-mix concrete (10) from the hopper (7) to the discharge openings (9).

24. Combination according to claim 19, wherein the device (1) has wheels (12) that can be supported on the rails (5).

25. Combination according to claim 20, wherein the device (1) has wheels (12) that can be supported on the rails (5).
